(19) United States
(12) Patent Application Publication
(10) Pub. No.: US 2022/0025558 A1
(43) Pub. Date: Jan. 27, 2022

(54) Printing Base Material Having Excellent Weathering Resistance

(71) Applicants: Asahi Kasei Advance Corporation, Tokyo (JP); Mik Kako Co., Ltd., Tokyo (JP)

(72) Inventors: Hideki Tsuno, Tokyo (JP); Shigeru Morita, Tokyo (JP); Shota Matsumoto, Osaka (JP)

(73) Assignees: Asahi Kasei Advance Corporation, Tokyo (JP); Mik Kako Co., Ltd., Osaka (JP)

(21) Appl. No.: 17/296,584

(22) PCT Filed: Nov. 15, 2019
(86) PCT No.: PCT/JP2019/044947

§ 371 Date: May 25, 2021

(30) Foreign Application Priority Data
Nov. 26, 2018 (JP) 2018-220087
Sep. 11, 2019 (JP) 2019-165358

(51) Int. Cl. D04H 1/435; D04H 3/011; D04H 3/16; D21H 13/24; G03G 7/00; G09F 3/02

(52) U.S. Cl. CPC D04H 1/435; D04H 3/011; D04H 3/16; D21H 13/24; D10B 2401/16; G09F 3/02; G09F 2003/0201; G09F 2003/0257; G03G 7/006

(57) ABSTRACT

Provided is a printing base material that can be printed by a laser printer, that has good (distinct) typability and printability, that remains durable (weather resistant) outdoors for three to six months or more, that has high productivity, that is low-cost, and that is configured from a polyester nonwoven fabric. In this printing base material, a binder layer serving as a printing surface is placed uniformly in the amount of 1.4 g/m² to 18 g/m² over the entire surface on one side of a polyester nonwoven fabric having a surface roughness (SMD) of 0.5 μm to 2 μm, a thickness of 40 μm to 300 μm, and a basis weight of 30 g/m² to 200 g/m², release paper may be placed using an adhesive layer on the surface on the side opposite from the binder layer, and the total thickness that can be printed by the laser printer is 90 μm to about 300 μm.

### FIELD

The present invention relates to a printing base material which can be printed on with a laser printer, which has suitable (distinct) typeability and printability, which is durable (weathering resistant) outdoors for three to six months or more, which has high productivity, which is low cost, and which is composed of a polyester nonwoven fabric.

### BACKGROUND

Though paper is the most widely used printing medium (base material), there are many applications in which paper cannot be used from the viewpoints of strength, water resistance, weathering resistance, and the like. Thus, as printing base materials to replace paper, for example, films, nonwoven fabrics, and woven fabrics have been developed for outdoor signboards and flags.

Patent Literature 1 below proposes a printing medium in which a synthetic resin is applied to one or both sides of a nonwoven fabric in an amount of 3 to 20 g/m² via an undercoat layer, but there are problems related to resin penetration during application and surface irregularities.

Patent Literature 2 below proposes a smooth sheet composed of undrawn fibers, the surface irregularities of which are improved by thermal compression bonding, but there are problems such as transparency and low concealability, and uneven breathability.

Patent Literature 3 below describes a nonwoven fabric in which a polyethylene resin is flash-spun, a polyester nonwoven fabric having a surface roughness (SMD) of 0.3 to 0.9, and a heat-sensitive recording medium comprising a coated heat-sensitive recording layer having a surface smoothness of 50 seconds or more and a surface roughness of 0.7 or less on one side thereof. Though the nonwoven fabric is satisfactory in surface roughness, there are problems such as lack of heat resistance at temperatures of 110° C. or higher, low hole-punching workability, and insufficient ink compatibility.

Patent Literature 4 below proposes a printed label in which a water-soluble polyester resin is applied to a polyester fiber base material and a nylon wet paint is then applied, but there are problems regarding adhesiveness between polyester fibers and the nylon resin, productivity in the process of solidifying in water, etc.

Patent Literature 5 below discloses a film-coated sheet having suitable printability and passability for laser printers and thermofusible transfer printers, but this coated sheet becomes film-like, which causes problems such as lack of breathability and flexibility, and lack of cloth-like tactile feeling.

Patent Literature 6 below describes a polyester spunbond laminated nonwoven fabric printing medium having an outer surface which is a smooth calendered surface having a surface roughness of 10 μm or less, comprising thermoplastic polymer continuous matrix filaments bonded together and having a specific porosity, but the thermoplastic polymer continuous matrix filaments have a trilobal cross-section, whereby a surface roughness of 2.0 μm or less is not achieved.

Patent Literature 7 below describes a nonwoven fabric printing medium containing substantially continuous polymer sheath-core spunbonded fibers and having a specific basis weight, tensile strength, and tear resistance, but the fibers constituting the obtained fabric are special sheath-core spunbond fibers, which are expensive, and although the surface smoothness is described, a surface roughness of 2.0 μm or less is not achieved.

Patent Literature 8 below describes a printable functional paper in which two types of resin coating layers are provided on a polyester nonwoven fabric, but a surface roughness of 2.0 μm or less is not achieved, and the cost is high because two kinds of resin coating layers are provided.

Patent Literature 9 below describes a printing base material in which a resin layer is provided on a flattened polyester nonwoven fabric, and which has a surface roughness of 15 to 18 μm, but a surface roughness of 2.0 μm or less is not achieved.

### CITATION LIST

### Patent Literature

[PTL 1] Japanese Patent No. 2619404

[PTL 2] Japanese Unexamined PCT Publication (Kohyo) No. 1-47588

[PTL 3] Japanese Unexamined Patent Publication (Kokai) No. 8-199467

[PTL 4] Japanese Patent No. 3151671

[PTL 5] Japanese Unexamined Patent Publication (Kokai) No. 5-11486

[PTL 6] WO 2005/000595

[PTL 7] WO 2008/112271

[PTL 8] Japanese Unexamined Patent Publication (Kokai) No. 2010-125799

[PTL 9] Japanese Unexamined Patent Publication (Kokai) No. 2011-230499

### SUMMARY

### Technical Problem

In light of the above prior art, an object of the present invention is to provide a printing base material which can be printed on with a laser printer, which has suitable (distinct) typeability and printability, which is durable (weathering resistant) outdoors for three to six months or more, which has high productivity, which is low cost, and which is composed of a polyester nonwoven fabric.

### Solution to Problem

As a result of rigorous investigation and repeated experimentation in order to achieve the above object, the present inventors have unexpectedly discovered that instead of thickening the binder layer provided on the surface of a polyester nonwoven fabric serving as a printing surface, the above object can be achieved by making the surface roughness (SMD) on the surface of the nonwoven fabric extremely small, providing an extremely thin binder layer on the entire surface, and optimizing the composition of the binder layer, and have completed the present invention.

Specifically, the present invention is as described below.

[1] A printing base material which can be printed on with a laser printer and which has a total thickness of 90 μm to approximately 300 μm, wherein a binder layer serving as a printing surface is uniformly arranged in an amount of 1.4 g/m² to 18 g/m² on an entire surface of one side of a polyester nonwoven fabric having a surface roughness (SMD) of 0.5 μm to 2 μm, a thickness of 40 μm to 300 μm, and a basis weight of 30 g/m² to 200 g/m², and a release paper may be arranged on a surface on a side opposite the binder layer via an adhesive layer.

[2] The printing base material according to [1], wherein the flattened polyester nonwoven fabric is a polyester spunbond nonwoven fabric having a partial thermal adhesion rate of 10 to 35%.

[3] The printing base material according to [1], wherein the flattened polyester nonwoven fabric is a paper-machined polyester staple fiber nonwoven fabric.

[4] The printing base material according to any one of [1] to [3], wherein the binder layer includes, as a toner fixing agent in an amount of 1 g/m² to 10 g/m², at least one resin selected from the group consisting of vinyl chloride/vinyl acetate copolymer resins, urethane-based resins, and mixtures thereof.

[5] The printing base material according to any one of [1] to [4], wherein the binder layer includes a UV absorption agent in an amount of 0.05 g/m² to 0.4 g/m².

[6] The printing base material according to any one of [1] to [5], wherein the binder layer includes white fine powder in an amount of 0.25 g/m² to 5 g/m².

[7] The printing base material according to any one of [1] to [6], wherein the binder layer includes an antistatic agent in an amount of 0.1 g/m² to 0.5 g/m².

[8] The printing base material according to any one of [1] to [7], for a printer sheet or a display label.

[9] A method for the production of a printing base material which can be printed on with a laser printer and which has a total thickness of 90 μm to approximately 300 μm, the method comprising the steps of:

calendering a polyester nonwoven fabric selected from the group consisting of polyester spunbond nonwoven fabrics having a partial thermal adhesion rate of 10 to 35% and paper-machined polyester staple fiber nonwoven fabrics to obtain a flattened polyester nonwoven fabric having a surface roughness (SMD) of 0.5 μm to 2 μm, a thickness of 40 μm to 300 μm, and a basis weight of 30 g/m² to 200 g/m²;

applying a resin solution comprising a toner fixing agent, a UV absorption agent, white fine powder, and an antistatic agent in a solvent onto an entire surface of one side of the obtained polyester nonwoven fabric and thereafter drying the solvent and/or crosslinking the resin to uniformly apply a binder layer serving as a printing surface in an amount of 1.4 g/m² to 18 g/m²; and

if necessary, arranging a release paper onto a surface of the polyester nonwoven fabric on a side opposite the binder layer via an adhesive layer to make the total thickness 90 μm to approximately 300 μm.

### Advantageous Effects of Invention

Since in the printing base material according to the present invention, the surface roughness of the surface of the nonwoven fabric is extremely small, an extremely thin binder layer is provided on the entire surface, and the composition of the binder layer is optimized, and since the printing base material can be printed on with a laser printer, has suitable (distinct) typeability and printability, is durable (weathering resistant) outdoors for three to six months or more, has high productivity, is low cost, and is composed of a polyester nonwoven fabric, the printing base material can be suitably used as a printing base material for various display labels, various packaging materials, signboards, flags, and pressure-sensitive papers, an in particular, as printing base material for which outdoor durability is required.

### DESCRIPTION OF EMBODIMENTS

The embodiments of the present invention will be described in detail below.

A first aspect of the present embodiment provides a printing base material which can be printed on with a laser printer and which has a total thickness of 90 μm to approximately 300 μm, in which a binder layer serving as a printing surface is uniformly arranged in an amount of 1.4 g/m² to 18 g/m² on an entire surface of one side of a polyester nonwoven fabric having a surface roughness (SMD) of 0.5 μm to 2 μm, a thickness of 40 μm to 300 μm, and a basis weight of 30 g/m² to 200 g/m², and a release paper may be arranged on a surface on a side opposite the binder layer via an adhesive layer.

The “flattened polyester nonwoven fabric” of the present embodiment is not particular limited, and may be a polyester spunbond nonwoven fabric having a partial thermal adhesion rate of 10 to 35%, or may be a paper-machined polyester staple fiber nonwoven fabric. However, it is necessary that the “flattened polyester nonwoven fabric” have a surface roughness (SMD) of 0.5 μm to 2 μm, a thickness of 40 μm to 300 μm, and a basis weight of 30 g/m² to 200 g/m², as will be described below.

In the polyester nonwoven fabric, it is preferable that the fiber arrangement of the fibers constituting the nonwoven fabric be equalized between the longitudinal direction (the direction of machining, the warp direction) and the direction orthogonal to the longitudinal direction (the weft direction). For example, the ratio of the tensile strength in the warp direction to the tensile strength in the weft direction (the warp direction/the weft direction) is preferably 0.5 to 8.0, more preferably 2.0 to 7.0, and further preferably 3.0 to 5.0. If the ratio of the tensile strength is less than 0.5 or more than 8.0, the direction of the sparse fiber arrangement becomes weak due to the bias of the arrangement of the constituent fibers, whereby the printing base material can easily tear.

The polyester nonwoven fabric can be produced by the spunbond method, the melt blowing method, the thermal bonding method, the spunlace method, or the paper-machining method. In particular, a nonwoven fabric produced by the spunbond method is preferred because it has high productivity, low cost, is excellent in heat resistance, and is thin and has high strength. The paper-machining method is preferable from the viewpoint that a nonwoven fabric having generally small surface roughness can be produced thereby, but when compared with a spunbond method, the productivity thereof is low.

The polyester nonwoven fabric may be a laminated nonwoven fabric, and may be of a multilayer structure such as SMS, SMMS, or SMSMS in which ultrafine fiber layers (M) produced by the melt blowing method and fiber layers (S) produced by the spunbond method are laminated.

When the nonwoven fabric has a multilayer structure, the bonding between fibers can be strengthened, and dispersibility of fibers becomes high, whereby the opacity (concealability) thereof can be improved. The fiber diameter (average fiber diameter) in the melt blowing method is preferably 1 to 7 μm, and more preferably 1.5 to 5 μm, and the fiber diameter (average fiber diameter) in the spunbond method is preferably 10 to 30 μm, and more preferably 12 to 25 μm.

Examples of the polymer constituting the polyester-based fibers constituting the polyester nonwoven fabric include polyethylene terephthalate, polypropylene terephthalate, polybutylene terephthalate, and polytrimethylene terephthalate. The polyester-based fibers may be polyester-based fibers in which isophthalic acid or phthalic acid is polymerized or copolymerized as an acid component forming an ester. The polyester-based fibers may be biodegradable fibers, for example, fibers composed of a polymer of poly(α-hydroxy acid) such as polyglycolic acid or polylactic acid, or fibers composed of a copolymer containing these as main repeating units. They may further be polyester blend fibers obtained by blending 0.5 to 10% by mass, with respect to the main component polyester resin, of another polymer such as a polyolefin-based polymer or a polyamide-based polymer. Though the fibers may be multicomponent fibers each composed of a plurality of different polymers, it is preferable that they be fibers composed of a single polymer from the viewpoint of smoothness, printability, and durability of the printing base material.

It should be noted that an additive such as titanium oxide for improving the whiteness of the fibers, a UV weathering agent, or a pigment can be kneaded and contained in the polyester-based fibers at 0.1 to 3% by mass of the resin within a range in which the desired effect is not impaired thereby.

### [Fiber Diameter]

The average fiber diameter of the polyester-based fibers constituting the polyester nonwoven fabric, which are located on the surface serving as the printing surface, is preferably 1 to 30 μm, more preferably 2 to 25 μm, and further preferably 3 to 20 μm. If the average diameter of the fibers is less than 1 μm, concealability and whiteness are improved, but strength and productivity are reduced. Conversely, if the average diameter exceeds 30 μm, strength and productivity can be improved, but concealability and whiteness may be reduced, whereby the surface roughness may not fall within the predetermined range. The entirety of the nonwoven fabric may be composed of fibers having substantially the same fiber diameter, or long fibers or staple fibers having different fiber diameters such as thin fibers and thick fibers may be laminated or mixed.

Note that the average fiber diameter (μm) is obtained by capturing an enlarged photograph at a magnification of 500-fold with a microscope, measuring the diameters of arbitrary 100 fibers, and using the average value thereof.

In the measurement of the average fiber diameter described above, it is preferable that the ratio of the number of fibers having a fiber diameter of 5 μm or less to the total measured number of fibers (hereinafter, also referred to as the fiber ratio) be 5% or less. When the fiber ratio of 5 μm or less is 5% or less, heat resistance and durability are suitable. The fiber ratio is more preferably 3% or less, and particularly preferably 1% or less. In the case of a laminated nonwoven fabric, a laminated nonwoven fabric containing no ultrafine fiber layer produced by the melt blowing method is preferred, and when an ultrafine fiber layer produced by the melt blowing method is contained in a laminated nonwoven fabric, the composition thereof is preferably set such that the ultrafine fiber layer as an inner layer is unlikely to appear on the surface.

Though the cross-sectional shape of the fibers is not particularly limited and may be any of a round cross-section, a flat cross-section, and an atypical cross-section, flat cross-sectional fibers having an aspect ratio of 1.2 or more is preferable because the strength of the nonwoven fabric after smoothing treatment can be ensured. The aspect ratio is more preferably 2.0 or more, and the aspect ratio is particularly preferably 3.0 to 5.0. The aspect ratio is obtained by observing a fiber cross-section to measure the length of the major axis and the minor axis, and using the following formula:

Aspect ratio=length of major axis/length of minor axis

In view of the strength, printability, and weathering resistance of the printing base material, the cross-sectional shape of the fibers is preferably a shape having no distinct unevenness, such as a round shape, an oval shape, or an I-like shape.

### [Surface Roughness (SMD)]

It is necessary that the surface roughness (SMD) of the polyester nonwoven fabric, on which a binder layer serving as a printing surface is arranged, be 0.5 μm to 2 μm. In the case of spunbond nonwoven fabrics, it is practically difficult to make the surface roughness less than 0.5 μm by calendering. Further, if the surface roughness is less than 0.5 μm, though the printability of the obtained printing base material for bar codes and characters is improved, the base material is excessively flat, whereby it is likely for two sheets to stick together due to the generation of static electricity as a result of frictional during feeding.

Conversely, if the surface roughness exceeds 2 μm, unevenness of the surface becomes large, and in, for example, a gravure printing process, the binder layer is adhered and formed only on protruding portions, and a thin binder layer is not uniformly formed on the entire surface, resulting in poor typeability and printability. Specifically, the typeability and printability of the obtained printing base material for bar codes and characters are reduced, which tends to bring about blurriness. If the unevenness of the surface increases, it is necessary to increase the amount of the binder layer in order to improve typeability and printability, but in this case, since the nonwoven fabric base material is excessively wetted and a long time is required for drying, productivity is lowered, and cost is high. Conversely, if the amount of the binder layer is small, not only are the typeability and printability reduced, but also the printer conveyability, the antistatic property, and the weathering resistance are reduced.

When the surface roughness is within the range of 0.5 μm to 2 μm, the surface is flat, and when printing is performed, there is no faintness or character skipping, and errors with barcodes or the like can be reduced.

### [Thickness]

It is necessary that the thickness of the polyester nonwoven fabric on which the binder layer is arranged be 40 μm to 300 μm.

It is necessary that the total thickness of the printing base material of the present embodiment be 90 μm to approximately 300 μm. When the total thickness of the printing base material including the release paper falls within this range, printer conveyability becomes suitable, and issues such as entrainment of the base material can be prevented. If the total thickness is less than 90 μm, the rigidity becomes low, and if the total thickness exceeds 300 μm, the rigidity becomes excessively high. A release paper may be arranged via an adhesive layer on the surface of the polyester nonwoven fabric serving as a printing surface opposite the binder layer. When a release paper is arranged on the printing base material, it becomes possible to simply attach the printing base material to a predetermined location to post the printed material by removing the release paper at the time of use. In the case of a printing base material on which no release paper is arranged, the thickness of the polyester nonwoven fabric itself may be 90 μm to 300 μm. In the case of a printing base material on which a release paper is arranged, it is necessary that the thickness of the polyester nonwoven fabric itself be 40 μm or more, and that the thickness thereof with the added release paper and the pressure-sensitive adhesive layer be 90 μm or more. If the thickness of the polyester nonwoven fabric itself is less than 40 μm, the thickness of the nonwoven fabric is small and the basis weight is also low, whereby coating with the resin solution becomes difficult and productivity is reduced. The thickness is preferably 80 μm or more. If the thickness of the printing base material is less than 90 μm, the durability of the printing base material is also reduced, resulting in a level at which a printing characteristic test cannot be performed, and the printer conveyability, typeability, printability, antistatic property, and weathering resistance are reduced. The total thickness of the printing base material is preferably from 95 to 230 μm, and more preferably from 110 to 200 μm.

### [Basis Weight]

It is necessary that the basis weight of the polyester nonwoven fabric on which the binder layer is arranged be 30 g/m² to 200 g/m². The basis weight of the polyester nonwoven fabric is preferably 40 to 150 g/m², more preferably 40 to 120 g/m², further preferably 45 to 120 g/m², and yet further preferably 50 to 100 g/m².

If the basis weight of the polyester nonwoven fabric is less than 30 g/m², a printing base material on which the release paper is not arranged has reduced rigidity, concealability, and strength. Conversely, if the basis weight exceeds 200 g/m², though rigidity, concealability, and strength are improved, the thickness becomes excessive.

Another aspect of the present embodiment provides a method for the production of a printing base material which can be printed on with a laser printer and which has a total thickness of 90 μm to approximately 300 μm, the method comprising the steps of:

calendering a polyester nonwoven fabric selected from the group consisting of polyester spunbond nonwoven fabrics having a partial thermal adhesion rate of 10 to 35% and paper-machined polyester staple fiber nonwoven fabrics to obtain a flattened polyester nonwoven fabric having a surface roughness (SMD) of 0.5 μm to 2 μm, a thickness of 40 μm to 300 μm, and a basis weight of 30 g/m² to 200 g/m²;

applying a resin solution comprising a toner fixing agent, a UV absorption agent, white fine powder, and an antistatic agent in a solvent onto an entire surface of one side of the obtained polyester nonwoven fabric and thereafter drying the solvent and/or crosslinking the resin to uniformly apply a binder layer serving as a printing surface in an amount of 1.4 g/m² to 18 g/m²; and

if necessary, arranging a release paper onto a surface of the polyester nonwoven fabric on a side opposite the binder layer via an adhesive layer to make the total thickness 90 μm to approximately 300 μm.

The printing base material of the present embodiment can be produced, for example, as follows.

An original fabric (mother roll) of a polyester nonwoven fabric selected from the group consisting of polyester spunbond nonwoven fabrics and paper-machined polyester staple fiber nonwoven fabrics is prepared, is cut to a predetermined width (inserting a slit), and calendered. A resin solution containing a toner fixing agent, a UV absorption agent, white fine powder, and an antistatic agent in a solvent is applied thereto. Thereafter, when a release paper is not provided, it is cut to a standard size (primarily A3 and A4 sizes), packed, packaged, and shipped without the application of an adhesive, and when a release paper is provided, it is combined with the release paper, cut to a standard size (primarily A3 and A4 sizes), packed, packaged, and shipped after the application of an adhesive.

### [Flattening]

The polyester nonwoven fabric on which a binder layer is arranged and which serves as the printing surface of the printing base material of the present embodiment can be a flattened polyester nonwoven fabric obtained by calendering a polyester nonwoven fabric selected from the group consisting of polyester spunbond nonwoven fabrics having a partial thermal adhesion rate of 10 to 35% and paper-machined polyester staple fiber nonwoven fabrics, and having a surface roughness (SMD) of 0.5 μm to 2 μm, a thickness of 40 μm to 300 μm, and a basis weight 30 g/m² to 200 g/m².

It is necessary that the binder layer serving as the printing surface be uniformly arranged on the flat surface in an amount of 1.4 g/m² to 18 g/m² after solvent drying.

The partial thermal compression bonding rate (the ratio of the compression bonded portion to the area of the entire nonwoven fabric) of the polyester spunbond nonwoven fabric to be subjected to calendering is preferably 10 to 35%, more preferably 12 to 30%, and further preferably 15 to 30%. If the partial thermal compression bonding rate is less than 10%, the bonding portion of the fibers is small, and the frictional strength and the rigidity of the surface are reduced. Conversely, if the partial thermal compression bonding rate exceeds 35%, the bonding portion of the fibers is increased, whereby the surface frictional strength and rigidity are increased, but the tear strength is reduced, which tends to lead to tearing.

As a processing condition of the partial thermal compression bonding, at, for example, a temperature at which the thermal compression bonding temperature is 20 to 60° C. lower than the melting point, the pressure is preferably 10 to 700 N/cm, and the pressure is more preferably 50 to 500 N/cm.

Though partial thermal compression bonding is performed using an embossing roller and a smoothing roller, the embossing pattern of the embossing roller is round, oval, diamond-shaped, columnar, or square, and is preferably evenly arranged in parallel or in a staggered arrangement. The area of one embossing pattern is preferably 0.3 to 5 mm², and more preferably 0.5 to 2 mm². The depth of the embossing pattern is preferably 0.01 to 0.6 mm, and more preferably 0.03 to 0.4 mm. The interval of the embossing pattern is preferably 0.5 to 10 mm, and more preferably 0.8 to 6 mm, and an evenly arranged pattern is preferable. In particular, it is preferable that the area and depth of one embossing pattern be small and surface unevenness be small. By adopting such partial thermal compression bonding, ruggedness such as tensile strength and tear strength is imparted, and adhesion is imparted between the constituent fibers, whereby a nonwoven fabric having a high surface frictional strength can be obtained.

Flattening is generally referred to as calendering or Schreiner processing, and is performed using, for example, or two or more of a pair of metal rollers, a metal roller/elastic roller, a metal roller/paper roller, and a metal roller/resin roller. In order to produce a uniform printing base material using a nonwoven fabric composed of fibers having a round cross-section and which were partially thermal compression bonded in advance, a higher degree of processing is preferable than conventional flattening processing. Specific advanced flattening processing conditions include, when the pressure width of the device is 120 cm and the width of the base material is 100 cm, processing at surface temperatures ranging from 120 to 240° C., preferably from 150 to 220° C., and linear pressures ranging from 400 to 2100 N/cm, preferably from 900 to 1800 N/cm. In the nonwoven fabric composed of flat cross-sectional fibers described above, a high degree of flattening is not required, and a desired nonwoven fabric can be obtained by processing under normal flattening processing conditions, for example, a surface temperature of 120 to 240° C. and a linear pressure of 200 to 400 N/cm.

When a paper-machined polyester staple fiber nonwoven fabric is calendered to obtain a flattened polyester nonwoven fabric, the same high degree of calendering conditions as described above can be adopted. Though it is difficult to increase the thickness of a paper-machined nonwoven fabric due to restrictions of the production method, a printing base material having an appropriate thickness and uniform thickness can be obtained by laminating a plurality of paper-machined staple fiber nonwoven fabrics and calendering them.

### [Binder Layer]

In the printing base material of the present embodiment, a resin composition can be applied so that a binder layer serving as the printing surface has a basis weight of 1.4 g/m² to 18 g/m² as a post-drying mass, and is uniformly arranged on the entire surface of one side of a polyester nonwoven fabric having a surface roughness (SMD) of 0.5 μm to 2 μm, a thickness of 70 μm to 300 μm, and a basis weight 30 g/m² to 200 g/m².

By providing a predetermined amount of a thin specific binder layer on the printing surface, during printing with a laser printer, it is possible to improve printability such as toner fixability, bar code/character sharpness, opacity (concealability), rigidity, water resistance, and durability (weathering resistance).

Note that in the printing base material of the present embodiment, it is confirmed that the thickness of the binder layer is extremely thin, and the surface roughness of the printing surface after arrangement of the binder layer is substantially identical to the surface roughness (SMD) of 0.5 μm to 2.0 μm of the flattened polyester nonwoven fabric prior to resin layer application.

In a laser printer, toner (powder ink) is placed on a black cylinder referred to as a drum by the force of static electricity, and the toner is pressed against the paper to print. Printing with a laser printer is performed by the following five steps: charging, exposure, development, transfer, and fixing.

The step of charging the entire drum with static electricity for the placement of toner on the drum is referred to as “charging.” At this time, the drum is charged to hundreds of volts.

The step of emission of a laser beam (light) toward the charged drum only in portions serving as the image or characters is referred to as “exposure.” The name “laser printer” is used because laser beams are used in this step. When applying the laser beam, a hexagonal mirror referred to as a polygon mirror is used. High-speed rotation of the polygon mirror allows the laser beam emitted from the light source to be applied in various directions.

When the drum is irradiated with a laser beam, the voltage at the part where the laser beam is applied drops (the voltage is lower only in the portions serving as the image or characters, and the voltage at other portions remains high).

When the charged toner is brought close to this drum, the toner moves to the portions (the portions serving as the image or characters) with low voltage on the drum. This step is referred to as “development.” In practice, the roller and the drum on which the toner is placed are in contact, and the toner moves due to the potential difference between the roller and the drum.

The toner that has moved to the drum is transferred to the paper (printing base material). When the paper is charged with static electricity opposite to the static electricity charged on the drum, toner is attracted from the drum to the paper by the force of the static electricity. This step is referred to as “transfer.” In practice, there is a roller for transfer, and electrical force is applied from the back of the paper for transferring.

Since the toner that has moved to the paper is still in a “resting” state on the paper, the process of applying pressure and heat to make the toner adhere to the paper so that the toner does not fall off the paper is referred to as “fixing.”

In the printing base material of the present embodiment, it is necessary to apply the resin composition so that the binder layer serving as a printing surface has a basis weight of 1.4 g/m² to 18 g/m² as a post-drying mass (in terms of solid content) so as to be uniformly arranged on the entire surface of one side of the polyester nonwoven fabric having a basis weight of 30 g/m² to 200 g/m².

If the binder layer is applied in an amount less than 1.4 g/m² as a post-drying mass, the printer conveyability, typeability and printability, and weathering resistance become poor. Conversely, if the amount of the binder layer exceeds 18 g/m² as a post-drying mass, since the binder layer is thick, the surface roughness of the printing base material becomes small, whereby though durability, printer conveyability, antistatic property, and weathering resistance become suitable, the amount of binder agent applied is excessively large, whereby a long drying time is required after coating, productivity is reduced and the cost is high, and in addition, after application, stickiness occurs and the powder can fall off (the applied solid components of the powder become excessive, bringing about a rough texture when touched by hand), whereby typeability and printability become unstable.

It is preferable that the binder layer contain at least one resin selected from the group consisting of vinyl chloride-vinyl acetate copolymer resins, urethane-based resins, and mixtures thereof as a toner fixing agent in an amount of 1 g/m² to 10 g/m² (mass per unit area of the printing base material) as a post-drying mass.

Toner fixing agents such as vinyl chloride-vinyl acetate copolymer resins and urethane-based resins also have a function of bonding the white fine powder, which is described below, to polyester fibers and a function of improving water, rain, etc., resistance because they are solvent-based.

If the amount of the toner fixing agent is less than 1 g/m², it is difficult to fix the toner, whereby weathering resistance is poor, and typeability and printability are reduced. If the amount exceeds 10 g/m², the printer may be damaged and productivity is reduced, resulting in high cost.

It is preferable that the binder layer contain a UV absorption agent in an amount of 0.05 g/m² to 0.4 g/m² as a post-drying mass.

If the UV absorption agent is contained in an amount less than 0.05 g/m², weathering resistance becomes poor. Conversely, if the UV absorption agent is contained in an amount exceeding 0.4 g/m², the printer may be damaged, typeability and printability become poor, and an excessive amount of the UV absorption agent is added, resulting in high cost.

It is preferable that the binder layer contain white fine powder in an amount of 0.25 g/m² to 5 g/m² as a post-drying mass.

The white fine powder can impart opacity (concealability) to the nonwoven fabric, and can serve as a sealant for gaps between the constituent fibers or thin portions generated by the partial thermal compression bonding, and can further impart water resistance, rigidity, and durability. Examples of the white fine powder include titanium oxide, calcium carbonate, magnesium carbonate, and clay having an average particle diameter of 0.1 to 2.0 μm, preferably 0.3 to 1.5 μm, and more preferably 0.3 to 0.5 μm.

If the white powder is contained in an amount less than 0.25 g/m², the whiteness of the printing surface is reduced, and typeability and printability become poor, resulting in printing lacking vividness. Conversely, if the white fine powder is contained in an amount exceeding 5 g/m², the printing roller of the gravure printing press may become jammed, whereby productivity is reduced.

It is preferable that the binder layer contain an antistatic agent in an amount of 0.1 g/m² to 0.5 g/m² as a post-drying mass.

When an antistatic agent is used, issues such as overlapping of two sheets at the time of feeding and static electrical discharge can be prevented.

Though an appropriate amount of static electricity is required for printing and copying with laser printers, if the amount of the antistatic agent is less than 0.1 g/m², printer conveyability, typeability, printability, and static electricity suppression become poor. Conversely, if the amount exceeds 0.5 g/m², static electricity suppression is poor, whereby typeability and printability become poor, and cost is high.

The binder layer may contain other additives such as a penetrant, a leveling agent, a crosslinking agent, and a water repellent within a range in which the desired effect is not impaired thereby.

The processing agent (resin solution) containing the toner fixing agent constituting the binder layer and the various additives is adjusted for viscosity in accordance with the processing method in a state in which the above components are dissolved or dispersed in a solvent. Thereafter, the processing agent is applied onto the surface of a polyester nonwoven fabric which has been subjected to flattening by a method such as a gravure method, a gravure offset method, a roll coating method, a comma coating method, or a knife coating method. In this embodiment, a gravure method is preferred from the viewpoint that the productivity thereof is superior to other methods, quality is also stable, low cost, and the product does not become excessively hard. However, in the gravure method, since it is difficult to uniformly apply to a nonwoven fabric having low flatness, it is preferable to use a nonwoven fabric subjected to the above-described high degree of flattening, particularly in the case of a nonwoven fabric subjected to partial thermal compression bonding.

For example, the concentration and viscosity of the processing agent can be adjusted with a diluent solvent, an additive, or a thickener, and the specific viscosity is preferably 50 to 10000 mPa/s/25° C., and more preferably 100 to 5000 mPa/s/25° C. Processing conditions such as drying temperature, crosslinking temperature, and processing speed are appropriately determined according to the processing method. For example, the temperature is preferably 80 to 200° C., and more preferably 100 to 180° C., the processing speed is preferably 10 to 200 m/min, and more preferably 15 to 150 m/min, and the drying (removal of diluent solvent) and crosslinking treatment can be performed with a cylinder dryer, a clip tenter, or a pin tenter. It should be noted that the coating of the processing agent may be performed across multiple repetitions depending on the type of various additives and the like.

### [Thickness of Printing Base Material]

As described above, it is necessary that the total thickness of the printing base material of the present embodiment be from 90 μm to about 300 μm. When the total thickness of the printing base material including the release paper falls within this range, printer conveyability becomes suitable, whereby issues such as rolling of the base material can be prevented. If the total thickness is less than 90 μm, the rigidity thereof becomes small, and the printer conveyability, typeability and printability due to rolling in the printer become poor. Conversely, if the total thickness exceeds 300 μm, the rigidity thereof becomes excessively large. A release paper may be arranged via an adhesive layer on the surface of the polyester nonwoven fabric serving as a printing surface opposite the binder layer. When a release paper is arranged on the printing base material, it becomes possible to simply attach the printing base material to a predetermined location to post the printed material by removing the release paper at the time of use. In the case of a printing base material which is not provided with a release paper, the thickness of the polyester nonwoven fabric itself may be 90 μm to 300 μm.

The total thickness of the printing base material of the present embodiment is preferably 100 to 300 μm, more preferably 100 to 250 μm, further preferably 120 to 250 μm, and yet further preferably 120 to 230 μm.

The mass per unit area of the printing base material of the present embodiment is preferably 45 to 200 g/m², more preferably 50 to 180 g/m², further preferably 50 to 150 g/m², and yet further preferably 60 to 150 g/m².

If the total thickness is less than 90 μm or the mass per unit area is less than 45 g/m², concealability, strength, and rigidity are reduced, and the paper feeding property and paper discharge property in a printer are reduced. Conversely, if the total thickness exceeds 300 μm or the mass per unit area exceeds 200 g/m², though concealability, strength, and rigidity become high, the paper feeding property and paper discharge property in a printer are reduced.

### [Tensile Strength of Printing Base Material]

When the printing base material of the present embodiment is used, for example, outdoors as a product label having mounting holes, it must be fastened and not torn when, for example, the product label is pulled by hand. Therefore, the printing base material of the present embodiment has a tensile strength of 100 N/5 cm or more, more preferably 120 N/5 cm or more, and further preferably 300 N/5 cm or more in both the longitudinal direction (warp direction) and in the direction orthogonal to the longitudinal direction (weft direction). If the tensile strength is less than 100 N/5 cm, it easily torn by fittings such as wire and string.

### [Tear Strength of Printing Base Material].

The tear strength of the printing base material of the present embodiment is preferably 1 N or more, more preferably 2 to 40 N, and further preferably 3 to 35 N, as measured in accordance with JIS-L-1906 (pendulum method). If the tear strength is less than 1 N, it becomes more likely to tear, resulting in a decrease in durability.

### [Print Base Material Opacity (Concealability)]

The opacity (concealability) of the printing base material of the present embodiment is preferably 70% or more, more preferably 75 to 100%, and further preferably 80 to 100%, depending on the fiber structure (fiber amount, fiber diameter, etc.) of the nonwoven fabric and the method of resin processing (the type of resin, coating amount, coating method, etc.). The opacity (concealability) is measured using a spectrophotometer. Using a Gretag-Macbeth spectrophotometer manufactured by Sakata Inx Corporation as the measuring instrument, opacity is determined using the following formula:

Opacity (%)={1−ΔL/ΔL0}×100,

from the color difference between a white plate and a black plate (ΔL0) and the color difference between whiteness and blackness of the sample (ΔL).

When the opacity is 70% or more, reading errors do not occur when a barcode or a QR Code™ is printed thereon, but if the opacity is less than 70%, issues tend to occur due to the influence of the back surface of the printing base material.

### [Heat Resistance of Printing Base Material]

It is necessary that the printing base material of the present embodiment have heat resistance such that deformation or shrinkage do not occur due to contact with the heating drum of a laser printer. For example, the dimensional change rate at a temperature of 200° C. is preferably 5% or less, and more preferably 0 to less than 3%. If the dimensional change rate exceeds 5%, thermal shrinkage, deformation, discoloration, or wrinkling tend to occur on the heating roll, and when the paper is fed or discharged, winding and curling on the heating drum tend to occur.

### [Water Resistance of Printing Base Material]

It is necessary that the printing base material of the present embodiment become discolored, deteriorated, changed, or torn even when used for an outdoor product label. Thus, it is preferable that it be difficult to wet with rain when used outdoors. Therefore, the water absorption of the printing base material of the present embodiment is preferably 3 minutes or more, more preferably 5 minutes or more, and further preferably 10 to 120 minutes, in the water absorption rate standard JIS-L-1907 (dropping method). If the water absorption rate is less than 3 minutes, durability is reduced due to the ease of wetting with water.

### [Release Paper and Adhesive Layer of Printing Base Material]

As described above, in the printing base material of the present embodiment, a release paper may be arranged on the surface of the polyester nonwoven fabric serving as a printing surface opposite to the binder layer via an adhesive layer. When a release paper is arranged on the printing base material, it becomes possible to simply attach the printing base material to a predetermined location to post the printed material by removing the release paper at the time of use.

The release paper and the adhesive layer are not particularly limited, and any known release paper and adhesive layer can be suitably used.

The thickness of the release paper may be, for example, 90 μm, and the thickness of the release paper and the adhesive layer can be, for example, 110 μm.

### EXAMPLES

Hereinafter, the present invention will be specifically described based on Examples and Comparative Examples, but the present invention is not limited to only these Examples.

The measurement methods of the characteristic values used in the following Examples and Comparative Examples are as follows.

(1) Basis Weight (g/m²): Samples having a length of 20 cm× a width of 25 cm are cut from three locations and weighed, and the average value is calculated by converting the average value into mass per unit (JIS-L-1906).
(2) Thickness (mm): Thickness is arbitrarily measured at 10 locations under a load of 10 kPa and the average thereof is shown.

### (3) Surface Roughness (SMD)

A sample having a size of 20 cm×20 cm is prepared from the base material. The tester uses a KES-FB4 surface-testing machine (with automatic-calculation function) manufactured by Kato Tech Co. Ltd. The sample is set in the test machine under a load of 400 g, a contact for surface roughness detection is brought into contact with the sample under a load of 10 g, and the instrument is started. The history of each sample is measured three times, and the average is taken as the surface roughness.

(4) Average Fiber Diameter and Fiber Ratio of Fibers having Average Fiber Diameter of 5 μm or less

Enlarged photographs of five positions in the thickness direction of a sample taken from an arbitrary position of a nonwoven fabric are captured at a magnification of 500-fold with an optical microscope, the lengths of the major axis and minor axis of a fiber cross-section are measured for 20 arbitrary fibers cut at substantially right angles in a direction crossing a fiber axis, the cross-sectional area of each fiber is obtained, and the diameter of a circle having the same area is defined as a fiber diameter. The average of all 100 fibers is defined as the average fiber diameter.

Regarding the fiber ratio of fibers having a diameter of 5 μm or less, when observation is difficult from a cross-sectional photograph, any 100 fibers having a thickness which can be identified from a surface photograph of the nonwoven fabric are selected, and the ratio of fibers having a fiber diameter of 5 μm or less is determined.

### (5) Fiber Aspect Ratio

Using the values of the lengths of the major axis and the minor axis obtained during the measurement of the average fiber diameter in (4) above, the aspect ratio is calculated by the following formula:

Flatness=Length of Major Axis/Length of Minor Axis

### (6) Productivity of Printing Base Material

The productivity of the coating in the production of the printing base material is evaluated by the following evaluation criteria.

“Excellent”: yield is 90% or more

“Good”: yield is 70% to less than 90%

“Acceptable”: yield is 50% to less than 70%

“Poor”: yield is less than 50%

### (7) Durability of Printing Base Material

The durability of the printing base material is evaluated from the tensile strength (N/5 cm) in the warp direction according to the following evaluation criteria. Tensile strength (N/5 cm) in the warp direction is measured using a constant-length tensile tester. Three samples having a width of 5 cm and a length of 30 cm are collected in the longitudinal direction (weft) and the direction orthogonal to the longitudinal direction (weft), and at a grip spacing of 20 cm and a tensile velocity of 10 cm/min, the tensile strengths thereof are measured to determine sensile strength in the longitudinal direction and the direction orthogonal to the longitudinal direction, and the average value (according to JIS-L-1913) is shown. Note that as used herein, the flow direction of the production machine is defined as the longitudinal direction (warp).

“Excellent”: tensile strength (N/5 cm) in the warp direction is 300 or more

“Good”: tensile strength (N/5 cm) in the warp direction is 200 to less than 300

“Acceptable”: tensile strength (N/5 cm) in the warp direction is 100 to less than 200

“Poor”: tensile strength (N/5 cm) in the warp direction is less than 100

### (8) Printer Conveyability

Using a RICOH “MP C8002” laser printer, and under the printing conditions of paper feed tray: manual feed tray, paper types: label paper or cardboard, the printer conveyability of the printing base material is evaluated according to the following evaluation criteria in accordance with the printing success rate.

“Excellent”: printing success rate is 90% or more

“Good”: printing success rate is 70% to less than 90%

“Acceptable”: printing success rate is 50% to less than 70%

“Poor”: printing success rate is less than 50%

### (9) Heat Resistance of Printing Base Material

The state of the above printer-conveyed printing base material is visually observed and evaluated by the following evaluation criteria.

“Excellent”: no thermal shrinkage, deformation, discoloration, or wrinkling are observed

“Good”: one of thermal shrinkage, deformation, discoloration, and wrinkling are slightly observed

“Acceptable”: one or two of thermal shrinkage, deformation, discoloration, and wrinkling are observed, but the degree thereof is small

“Poor”: two or more of thermal shrinkage, deformation, discoloration, and wrinkling is apparent

### (10) Typeability and Printability

Typeability and printability are evaluated on the basis of the following evaluation criteria by visually observing the state of bleeding, blurring, and ink splattering (scattering) by printing characters and photographs with a laser printer.

“Excellent”: can be read clearly with little bleeding, blurring, ink splattering (scattering), stickiness, or powder dusting

“Good”: there is a small amount bleeding, blurring, ink splattering (scattering), stickiness, or powder dusting, but reading is not impaired

“Acceptable”: there is bleeding, blurring, ink splattering (scattering), stickiness, or powder dusting, but reading is not impaired

“Poor”: reading of print and photographs is poor due to bleeding, blurring, or ink splattering (scattering), or it is difficult to handle the printed object due to stickiness or powder dusting

“−”: a printed product cannot be obtained because the base material cannot be conveyed in the printer

### (11) Antistatic Property (Static Electricity Suppression)

The antistatic property is evaluated by the adhesive property due to static electricity after printing according to the following evaluation criteria.

“Excellent”: no adhesion

“Good”: there is some adhesion

“Acceptable”: there is adhesion

“Poor”: cannot print

### (12) Weathering Resistance

A printed object on which characters or an image was printed with a laser printer was tested under conditions corresponding to the conditions of being left outdoors for six months (irradiated at a temperature of 65° C. for 100 hours with a xenon weather meter), and weathering resistance was evaluated by visual observation according to the following evaluation criteria.

“Excellent”: no discoloration

“Good”: there is slight discoloration, but it is not noticeable

“Acceptable”: severe discoloration

“Poor”: the characters or picture cannot be read

### Example 1

Polyethylene terephthalate (PET, melting point 265° C.) was spun from a spunbonding spinneret at a spinneret temperature of 300° C., a thermoplastic fiber web having a round cross-section, a flatness of 1.0, an average fiber diameter of 12 μm (a fiber ratio of fibers having a fiber diameter of 5 μm or less of 0%), and a basis weight of 70 g/m² was obtained. The obtained web was thermal compression bonded between a pair of uneven embossing rollers and smooth metal rollers under the condition of a linear pressure of 350 N/cm and upper and lower temperatures of 225° C./220° C., whereby a polyester spunbond nonwoven fabric having a partial thermal compression bonding rate of 15% was obtained.

The obtained polyester spunbond nonwoven fabric was calendered at a linear pressure of 1620 N/cm and a surface temperature of 165° C., whereby a flattened polyester spunbond nonwoven fabric having a surface roughness (SMD) of 1.520, a thickness of 171 μm, and a basis weight 70 g/m² was obtained. A resin solution containing a vinyl chloride-vinyl acetate copolymer resin, a white fine powder, a UV absorption agent, and an antistatic agent as a toner fixing agent (a solid concentration of 42% by weight) in a mixed solvent of methyl ethyl ketone and toluene (mixing ratio: 1:1) was applied to the entirety of one surface of the obtained polyester spunbond nonwoven fabric with a gravure coater in an amount of 14.8 ml/m² of the nonwoven fabric, and the solvent was then dried at 80° C. and/or the resin was crosslinked to prepare a printing base material in which a binder layer serving as a printing surface was uniformly arranged in an amount of 6.22 g/m² in terms of solid content.

The physical properties and printing characteristics of the obtained nonwoven fabric and the printing base material are shown in Table 1 below.

### Example 2

A printing base material was prepared in the same manner as in Example 1, except that a machined paper produced by Tentok Paper Co., Ltd., consisting of 100% polyester, having a basis weight of 75 g/m² and subjected to calendering, was used instead of the polyester spunbond nonwoven fabric. The physical properties and printing characteristics of the machined paper and the printing base material are shown in Table 1 below.

### Example 3

A printing base material was produced in the same manner as in Example 1 except that machined paper polyester spunbond nonwoven fabric composed of a flat yarn having a flatness of 3.3 (23 μm on the long side-7 μm on the short side) and having a small thickness, a low basis weight, and a small surface roughness was used, and the calendering conditions include a linear pressure of 245 N/cm and a surface temperature of 230° C., and a release paper was attached thereto. The physical properties and printing characteristics of the nonwoven fabric and the printing base material are shown in Table 1 below. Though wrinkling occurred during processing because the thickness was small and the basis weight was low and productivity was thus slightly reduced by attempts at the suppression thereof, the thickness of the printing base material was within an appropriate range due to the arrangement of the release paper, and printing performance was suitable.

### Comparative Example 1

A printing base material was prepared in the same manner as in Example 1, except that the calendering conditions were changed to a linear pressure of 500 N/cm and a surface temperature of 165° C., and a polyester spunbond nonwoven fabric having a large surface roughness was used. The physical properties and printing characteristics of the nonwoven fabric and the printing base material are shown in Table 1 below.

Since the surface roughness of the nonwoven fabric was large, unevenness remained on the surface, and flatness was lacking, and the binder layer was arranged only on protruding portions, whereby typeability and printability were reduced, and the antistatic property and the weathering resistance were also reduced.

### Comparative Example 2

A printing base material was prepared in the same manner as in Example 3, except that a release paper was not attached. The physical properties and printing characteristics of the nonwoven fabric and the printing base material are shown in Table 1 below. Since the nonwoven fabric had a low basis weight and a small thickness, productivity was reduced, and since the thickness of the printing base material was less than 90 μm, and the durability of the printing base material was reduced, resulting in a level at which the printing characteristic test could not be performed. Thus, the printer conveyability, typeability, printability, antistatic property, and weathering resistance thereof were reduced.

### Comparative Example 3

A printing base material was prepared in the same manner as in Example 1, except that a polyester spunbond nonwoven fabric having a high basis weight and a large thickness was used. The physical properties and printing characteristics of the nonwoven fabric and the printing base material are shown in Table 1 below. Since the thickness of the printing base material exceeded 300 μm, productivity and durability were suitable, but printer conveyability, typeability, printability, antistatic property, and weathering resistance thereof were reduced.

### Comparative Example 4

A printing base material was prepared in the same manner as in Example 1, except that the binder layer was set to an amount exceeding 18 g/m² as a solid content conversion. The physical properties and printing characteristics of the nonwoven fabric and the printing base material are shown in Table 1 below. Since the binder layer was thick, the surface roughness of the printing base material was small, and the durability, printer conveyability, antistatic property, and weathering resistance were suitable, but since the amount of binder agent applied was excessively large, a long drying time was required after coating, and stickiness and powder dusting occurred after coating, whereby typeability and printability were not stable.

TABLE 1

| Example | | | Comp. Example | | | |
|---|---|---|---|---|---|---|
| 1 | 2 | 3 | 1 | 2 | 3 | 4 |

Base Material Properties (Raw Material)

| | | | | | | | | |
|---|---|---|---|---|---|---|---|---|
| Basis Weight | g/m² | 70 | 75 | 45 | 70 | 45 | 182 | 70 |
| Thickness | μm | 171 | 96 | 70 | 192 | 70 | 388 | 171 |
| Average Fiber Diameter | μm | 12 | | 14 | 12 | 14 | | 12 |
| (5 μm or less ratio) | % | 0 | | 0 | 0 | 0 | | 0 |
| Aspect Ratio | — | 1.0 | | 3.3 | 1.0 | 3.3 | | 1.0 |
| Surface Roughness (SMD) | μm | 1.520 | 0.527 | 0.833 | 3.474 | 0.833 | 1.346 | 1.520 |
| | | SB | Machined Paper | SB | SB | SB | SB | SB |

Binder Layer

| | | | | | | | | |
|---|---|---|---|---|---|---|---|---|
| PVC/Vinyl Acetate Copolymer | g/m² | 3.20 | 3.20 | 3.20 | 3.20 | 3.20 | 3.20 | 12.80 |
| White Fine Powder | | 2.60 | 2.60 | 2.60 | 2.60 | 2.60 | 2.60 | 7.80 |
| UV Absorption Agent | | 0.24 | 0.24 | 0.24 | 0.24 | 0.24 | 0.24 | 0.50 |
| Antistatic Agent | | 0.18 | 0.18 | 0.18 | 0.18 | 0.18 | 0.18 | 1.00 |
| Active Ingredients (Total) | | 6.22 | 6.22 | 6.22 | 6.22 | 6.22 | 6.22 | 22.10 |

| | | | | | | | |
|---|---|---|---|---|---|---|---|
| Productivity | Exc | Exc | Good | Exc | Acc | Exc | Acc |

Physical Characteristics/Properties of Printing Base Material (After Processing/Product)

| | | | | | | | | |
|---|---|---|---|---|---|---|---|---|
| Basis Weight | g/m² | 76.2 | 81.2 | 141.2 | 76.2 | 51.2 | 188.2 | 92.1 |
| Thickness | μm | 192 | 101 | 194 | 208 | 84 | 401 | 207 |
| Surface Roughness (SMD) | μm | 1.470 | 0.513 | 0.766 | 3.332 | 0.766 | 1.245 | 1.112 |
| Thickness of Adhesive + | μm | 0 | 0 | 110 | 0 | 0 | 0 | 0 |
| Release Paper | | | | | | | | |

Printing Characteristics

| | | | | | | | |
|---|---|---|---|---|---|---|---|
| Durability | Exc | Exc | Exc | Exc | Acc | Exc | Exc |
| Heat Resistance | Exc | Exc | Exc | Exc | Exc | Acc | Exc |
| Printer Passability | Exc | Exc | Exc | Exc | Poor | Poor | Good |
| Typeability/Printability | Good | Exc | Exc | Poor | — | — | Poor |
| Electrostatic | Exc | Exc | Exc | Good | — | — | Exc |
| Weathering Resistance | Exc | Exc | Exc | Good | — | — | Exc |

### INDUSTRIAL APPLICABILITY

Since in the printing base material according to the present invention, the surface roughness of the surface of the nonwoven fabric is extremely small, an extremely thin binder layer is provided on the entire surface, and the composition of the binder layer is optimized, and since the printing base material can be printed on with a laser printer, has suitable (distinct) typeability and printability, is durable (weathering resistant) outdoors for three to six months or more, has high productivity, is low cost, and is composed of a polyester nonwoven fabric, the printing base material can be suitably used as a printing base material for various display labels, various packaging materials, signboards, flags, and pressure-sensitive papers, an in particular, as printing base material for which outdoor durability is required.

1: A printing base material which can be printed on with a laser printer and which has a total thickness of 90 μm to approximately 300 μm, wherein a binder layer serving as a printing surface is uniformly arranged in an amount of 1.4 g/m² to 18 g/m² on an entire surface of one side of a polyester nonwoven fabric having a surface roughness (SMD) of 0.5 μm to 2 μm, a thickness of 40 μm to 300 μm, and a basis weight of 30 g/m² to 200 g/m², and a release paper may be arranged on a surface on a side opposite the binder layer via an adhesive layer.

2: The printing base material according to claim 1, wherein the flattened polyester nonwoven fabric is a polyester spunbond nonwoven fabric having a partial thermal adhesion rate of 10 to 35%.

3: The printing base material according to claim 1, wherein the flattened polyester nonwoven fabric is a paper-machined polyester staple fiber nonwoven fabric.

4: The printing base material according to claim 1, wherein the binder layer includes, as a toner fixing agent in an amount of 1 g/m² to 10 g/m², at least one resin selected from the group consisting of vinyl chloride/vinyl acetate copolymer resins, urethane-based resins, and mixtures thereof.

5: The printing base material according to claim 1, wherein the binder layer includes a UV absorption agent in an amount of 0.05 g/m² to 0.4 g/m².

6: The printing base material according to claim 1, wherein the binder layer includes white fine powder in an amount of 0.25 g/m² to 5 g/m².

7: The printing base material according to claim 1, wherein the binder layer includes an antistatic agent in an amount of 0.1 g/m² to 0.5 g/m².

8: The printing base material according to claim 1, for a printer sheet or a display label.

9: A method for the production of a printing base material which can be printed on with a laser printer and which has a total thickness of 90 μm to approximately 300 μm, the method comprising the steps of:
calendering a polyester nonwoven fabric selected from the group consisting of polyester spunbond nonwoven fabrics having a partial thermal adhesion rate of 10 to 35% and paper-machined polyester staple fiber nonwoven fabrics to obtain a flattened polyester nonwoven fabric having a surface roughness (SMD) of 0.5 μm to 2 μm, a thickness of 40 μm to 300 μm, and a basis weight of 30 g/m² to 200 g/m²;
applying a resin solution comprising a toner fixing agent, a UV absorption agent, white fine powder, and an antistatic agent in a solvent onto an entire surface of one side of the obtained polyester nonwoven fabric and thereafter drying the solvent and/or crosslinking the resin to uniformly apply a binder layer serving as a printing surface in an amount of 1.4 g/m² to 18 g/m²; and
if necessary, arranging a release paper onto a surface of the polyester nonwoven fabric on a side opposite the binder layer via an adhesive layer to make the total thickness 90 μm to approximately 300 μm.
